(19) United States
(12) Patent Application Publication
(10) Pub. No.: US 2013/0045080 A1
(43) Pub. Date: Feb. 21, 2013

(54) CROSS FLOW WIND OR HYDROKINETIC TURBINES

(71) Applicant: Brian Kinloch Kirke, Adelaide (AU)

(72) Inventor: Brian Kinloch Kirke, Adelaide (AU)

(21) Appl. No.: 13/639,863

(22) PCT Filed: Apr. 18, 2011
(86) PCT No.: PCT/AU2011/000464

§ 371 Date: Oct. 7, 2012

(30) Foreign Application Priority Data
Apr. 18, 2010 (AU) 2010901616

(51) Int. Cl. F03D 3/06; F03D 7/06; F03D 11/00

(52) U.S. Cl. 415/53.1; 416/119; 416/44

(57) ABSTRACT

A turbine (10) comprising a turbine rotor (11) having a blade support frame (13), and a plurality of blades (12) each pivotally mounted adjacent to its leading edge to the frame (13) for rotation about an axis extending substantially parallel to the axis of rotation of the rotor (11) with the trailing edge of each blade (12) being capable of pivoting downstream or downwind due to fluid dynamic forces on each blade. Pitch control means in the form of a ring or guide (23) is located around the shaft (15) and is coupled via links or lines (20) to the trailing end of each blade (12) to control the pitch of each blade (12) during rotation of the turbine rotor (11).

### TECHNICAL FIELD

This invention relates to cross flow wind or hydrokinetic turbines and in particular to turbines which includes passive means to control the pitch of the blades of the turbines.

### BACKGROUND ART

Cross flow Darrieus type wind and water turbines have a number of inherent disadvantages. They lack starting torque, have low efficiency and where hydrokinetic turbines have their blades at a fixed pitch, excessive vibration occurs. To overcome these disadvantages, turbines have been proposed which have different mechanisms for adjusting the pitch of the blades of the turbines. Generally the mechanisms which have been proposed or used for this purpose are relatively complex.

A further disadvantage of turbines of the above type is that they use large shafts which are relatively expensive and step-up gearboxes or multipole generators due to the low rotational speed achieved with such turbines.

Patent application Nos. WO2001062018, WO2009082352 and KR2004002831 disclose eccentrics and cams to vary the pitch of the blades of a turbine, however the eccentrics and cams used in these applications are driven by external means.

### SUMMARY OF THE INVENTION

The present invention thus provides in a preferred aspect a turbine comprising a turbine rotor having an axis of rotation, a blade support frame, a plurality of blades spaced from and extending substantially parallel to the axis of rotation of said rotor, each said blade being pivotally mounted adjacent to its leading edge to said frame for rotation about an axis extending substantially parallel to said axis of rotation, the trailing edge of each said blade being capable of pivoting downstream or downwind due to fluid dynamic forces on each said blade whereby the angle of attack of each said blade subject to said forces is reduced, and pitch control means coupled to each of said blades adjacent the trailing edges thereof, said pitch control means being adapted to control the pitch of each said blade in response to rotation of said turbine rotor.

The pitch control means may comprise a pitch control member which is free to move a limited distance in any radial direction relative to the axis of rotation of the turbine and means which couple each blade adjacent its trailing edge to the member. Suitably the blades are at a common radius relative to the axis of rotation of the turbine.

Means are suitably provided for limiting the radial travel of the pitch control member in such a way that member is always at its downstream limit of travel due to the downstream forces acting on the blades and is therefore eccentric relative to the rotor axis of rotation, the blades thereby being constrained to pitch in an approximately sinusoidal motion during rotation of the rotor frame. The pitch control member allows the blades to pitch with trailing edge downstream as they move across the flow on both their upwind/upstream and downwind/downstream passes. Blades which travel upstream and downstream are constrained to near zero pitch.

The blade support frame is suitably mounted on or includes a central shaft extending along the axis of rotation.

The pitch control member may include a circular opening such that in one embodiment, the member can locate around the central shaft with suitable clearance. Suitably the circular opening is arranged centrally of the member. The radial movement of the pitch control member is thus limited by contact between the inner wall, surface or edge of the opening and the shaft.

The means of coupling the trailing edge of each blade to the member suitably comprises a rigid link or flexible line or cable. All links or all lines or cables which couple each blade to the member are suitably of substantially the same length. Further the rigid link, flexible line or cable are connected to the pitch control member at a common radius relative to the circular opening and at equi-spaced circumferential positions. In a particularly preferred form, the pitch control member is in the form of a ring or annular member so as minimize drag. During rotation of the turbine rotor, the pitch control member rotates eccentrically around the shaft of the rotor under the influence of the fluid dynamic forces of the turbine blades which offsets the control member relative to the shaft.

Where the coupling means comprises a rigid link, the pitch control member may include a circular groove or a plurality of part circular grooves arranged concentrically on the same radius relative to the axis of the opening of the pitch control member and the ends of the rigid links or pins attached to the links are located within the groove or respective grooves. The links suitably terminate in rollers which are located within the groove or respective grooves. Means are suitably provided to constrain the links to move in a radial direction relative to the axis of rotation. Such means may comprise guides associated with each link which allow longitudinal movement of the links but prevent or limit lateral movement thereof.

As the turbine rotor rotates therefore, the links are constrained against movement laterally but the ends thereof are capable of relative movement in a tangential direction in opposite directions along the groove or grooves.

Where the coupling means comprises a flexible line or cable, respective lines or cables are attached at their outer ends to respective blades adjacent the trailing edges thereof and attached at their respective inner ends to the pitch control member at equi-spaced circumferential positions and at a common radius from the centre of the opening in the member. The pitch control member in this embodiment may comprise a simple annular member or ring. The fluid dynamic forces on the blades during rotation is transferred through the lines or cables to the ring or annular member which offsets the ring or annular member such that it moves eccentrically during rotation of the rotor.

In another embodiment, the pitch control member may have a central axis and a plurality circumferentially spaced pitch adjustment members or tabs corresponding in number and spacing to the number of blades, the pitch control member having radial dimensions or a diameter approximately equal to that of the complete turbine rotor such that the pitch adjustment members or tabs are located adjacent respective blades. Each member or tab may include a slot which extends in a circumferential direction relative to the central axis of the pitch control member. Each blade may include means at or adjacent its trailing edge for cooperation with a slot in a member or tab for movement in opposite directions along a slot. Such means may comprise a pin or a roller.

The pitch control member may have a central opening which is of a diameter greater than the diameter on which the blades are located relative to the axis of rotation of the turbine rotor. Thus the wall or edge of the opening is radially externally of the blades. In this embodiment, the pitch adjustment members or tabs extend to the inner side of the opening. Preferably the pitch control member in this embodiment is in the form of an annular member or ring which is located radially externally of the blades.

Stop means may be provided to limit pitch amplitude of the blades. The stop means may be provided on the inner side of the opening and in the path of radial movement of the pitch control member towards or away from the support frame of the turbine rotor. The position of the stop means may be adjustable to enable maximum pitch amplitude of the blades to be selectively varied. Where the pitch control member comprise an annular member or ring, the stop means may be provided at a circumferential spacing around the ring corresponding to the spacing of the blades and are adapted to abut the blades on the upstream side to limit radial movement of the pitch control member and thereby the maximum pitch amplitude of the blades.

In another embodiment, the pitch control member may be located radially inwardly of the blades and have respective pitch adjustment members or tabs on the outside thereof which are located adjacent each blade. The pitch adjustment members or tabs may have as above circumferentially extending slots with which trailing ends or edges of respective blades are adapted to cooperate through pins or rollers.

The pitch control member in this embodiment may also be in the configuration of an annular member or ring having an outer diameter less than the diameter on which the blades are located. Preferably pitch amplitude of the blades is limited by radial movement of the pitch control member towards and abutment with an opposing blade. Adjustable stop means which are adjustable towards and away from the blades may be provided on the pitch control member to enable adjustment to the maximum pitch amplitude of the blades.

The blade support frame of the rotor in one form may comprise axially spaced apart sets of radial arms, each blade being pivotally mounted at each end and at a suitable distance from their leading edges to opposite ends to the corresponding radial arms of each set.

The rotor frame alternatively may comprise a pair of axially spaced apart discs or annular members, the blades being pivotally mounted at each end to the discs or annular members. One or more wheels may be provided in peripheral contact with the outer periphery of one or both of said discs or the inner or outer periphery of one or both of the annular members to enable energy to be extracted therefrom. The wheels may be in frictional contact with the discs or annular members. Alternatively the wheels and discs or annular members may have gear teeth, the gear teeth of the wheels and discs or annular members being in meshing engagement.

The axis of rotation of the turbine in water may be inclined in use at an angle of approximately 30° to the vertical or 60° to flow direction to increase the effective swept area.

The turbine may be combined with a diffuser, the diffuser suitably being of circular cross section and comprising a cylindrical section in which the turbine is located, and a trailing divergent section. The divergent section may comprise a plurality of slats defining slots therebetween through which fluid may flow to keep the flow attached. The slats may comprise aerofoil slats which may be cambered and outwardly angled.

An over-speed prevention mechanism comprising a preloaded compression spring may be provided between an inner end of each rod or cable and pitch control member. When the desired maximum rotational speed is reached, centrifugal forces on a blade overcome the spring preload and compress the spring, thereby allowing rotation of a blade to reduce the aerodynamic efficiency and limit the rotational speed of the turbine. Alternatively, a preloaded tension spring may be provided, in which case centrifugal force on the blade beyond a predetermined limit will extend the spring and allow blade rotation.

A deactivation mechanism may be provided to allow the blades to pivot freely without the constraint of the pitch control member. The deactivation mechanism may comprise a releasable over-centre link assembly associated with each blade, the link assembly being releasable to allow the blades to pivot freely. An over-centre link assembly is suitably connected between the link or cable and line and pitch control member. The link assembly may be associated with the over-speed prevention mechanism and provided in series with that mechanism between the link, or cable or line and pitch control member.

### BRIEF DESCRIPTION OF THE DRAWINGS

Reference will now be made to the accompanying drawings which illustrate preferred embodiments of the invention described primarily in relation to hydrokinetic turbines. The principles of the present invention however may be also applied to wind turbines and the reference to turbines in the following description includes both hydrokinetic turbines and wind turbines. In the accompanying drawings:

FIG. 1 is a schematic isometric view of a turbine during rotation according to a first embodiment of the present invention in which the pitch adjusting mechanism is internally of the turbine blades;

FIGS. 1(a) is an enlarged sectional view along line A-A of FIG. 1;

FIG. 1(b) is an enlarged sectional view along line A-A of FIG. 1 with the turbine rotor rotated through an angle of 60 degrees;

FIG. 2 is a view corresponding to the view of FIG. 1(b) of a turbine rotor with a pitch adjusting mechanism adjacent to the central shaft according to a second embodiment of the present invention;

FIGS. 3(a) and 3(b) illustrate in views corresponding to FIG. 1(b) a turbine rotor according to further embodiments of the present invention in which the pitch adjusting mechanism is based on a ring just outside or just inside the turbine blades respectively;

FIG. 4 is a schematic isometric view showing a turbine rotor including an alternative blade mounting arrangement for the turbine blades with the blade pitch adjustment mechanism removed;

FIG. 5 is a schematic isometric view showing a further turbine rotor with the blade pitch adjustment mechanism removed but incorporating means for extracting energy from the rotor;

FIG. 6 is an isometric view showing a further turbine rotor with the blade pitch adjustment mechanism removed incorporating alternative means for extracting energy therefrom;

FIG. 7 is a schematic sectional view of a turbine rotor which is angled to the direction of fluid flow;

FIGS. 8(a) and 8(b) illustrate in sectional side and end views a turbine rotor associated with a fluid guiding shroud;

FIG. 9 illustrates in plan view an over-speed prevention mechanism and a deactivation mechanism for use with blades of the turbine;

FIG. 10 is a sectional elevation view along line B-B of FIG. 9; and

FIGS. 11 and 12 illustrate the operation of the mechanisms of FIG. 9.

### DESCRIPTION OF THE PREFERRED EMBODIMENTS

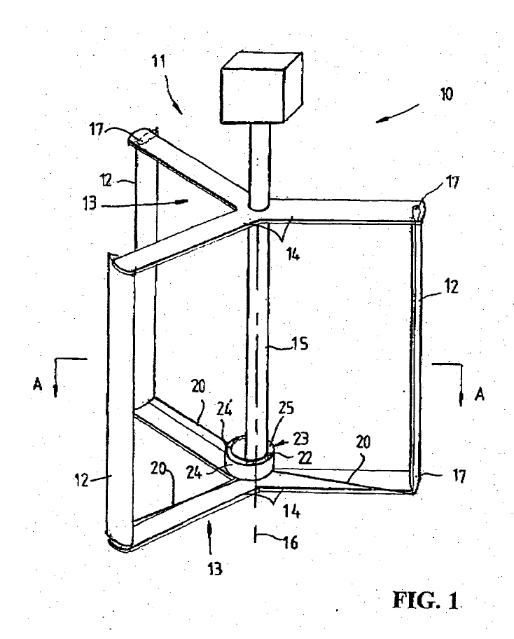

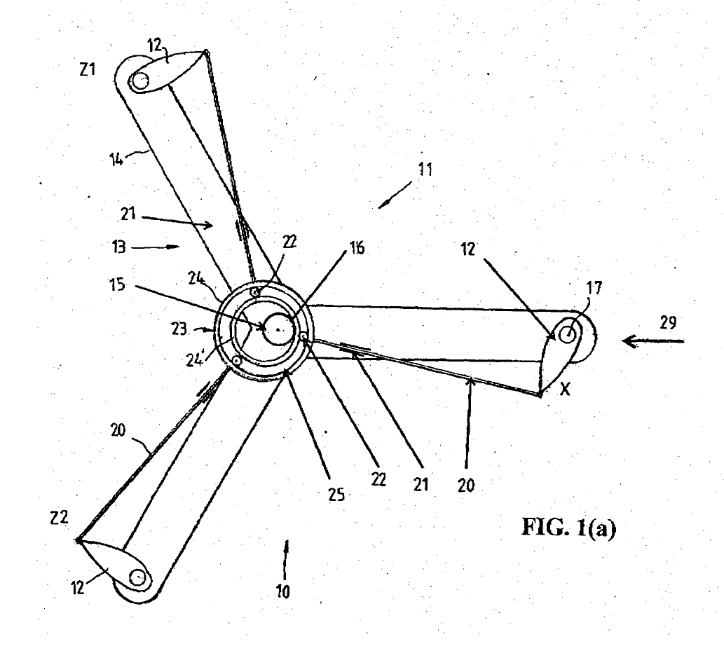

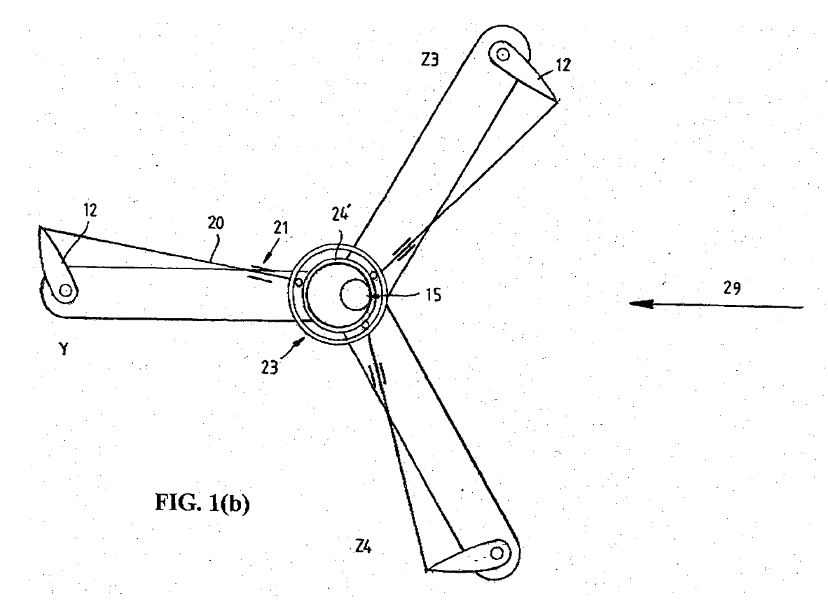

Referring to the drawings and firstly to FIGS. 1, 1(a) and (b), there is illustrated a turbine 10 according to one preferred embodiment of the invention comprising a turbine rotor 11 having a plurality of straight or linear blades 12, in this case three blades, which are mounted on a common radius and at equi-spaced circumferential positions to a support frame comprising first and second sets 13 of radial arms 14, each set 13 of arms 14 being fixedly mounted at spaced apart axial positions to a central shaft 15. The blades 11 are mounted to the arms 14 so that they are maintained parallel to the axis of rotation 16 of the turbine rotor 11 defined by the shaft 15.

Each blade 12 is pivotally attached adjacent its leading edge at opposite end pivot points 17 to two axially spaced apart parallel radial arms 14 such that each blade 12 is pivotally mounted to and extends between pairs of spaced aims 14. A rigid link 20 is pivotally attached to each blade 12 adjacent its trailing edge 18 and each link 20 is constrained to move in a radial direction by respective guides 21 which allow free movement of each link 20 in opposite longitudinal directions but which restrain lateral movement. Each link 20 is provided with a roller 22 at its inner end which is mounted to the link 20 for rotation about an axis parallel to the axis of rotation 16 of the turbine rotor 11. The links 20 are all of the same length. An annular guide 23 is located around the shaft 15 with clearance and comprises first and second concentric ring-shaped or annular walls 24 and 24′ which define an annular groove, slot or track 25 therebetween in which each roller 22 is free to roll. The guide 23 can move a limited distance as limited by the shaft 15 in any radial direction. As an alternative, the annular groove or slot 25 may be replaced by a plurality of separate grooves on a common radius, each of which receives a roller 22. The grooves or slots 25 in this embodiment extend circumferentially a distance sufficient to accommodate tangential movement of the rollers 22 in opposite directions as described further below.

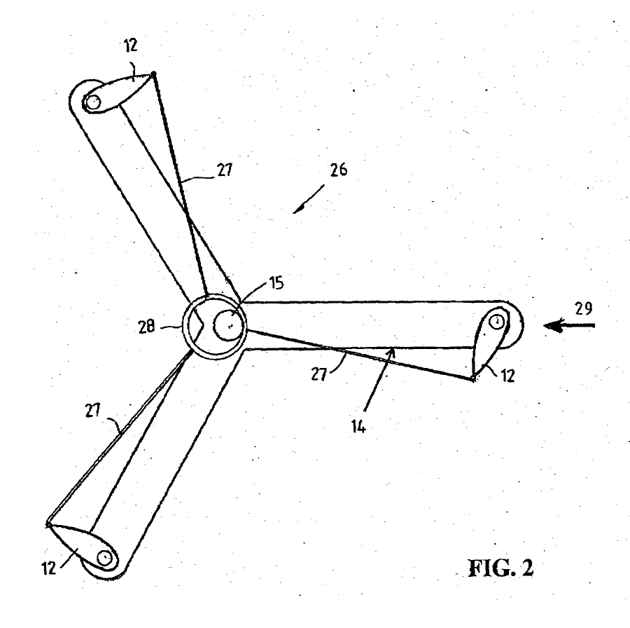

FIG. 2 illustrates a second preferred embodiment of turbine rotor 26 according to the invention suited to small wind turbines. The turbine rotor 26 has a number of components which are similar to the components of the turbine 10 of FIG. 1 and accordingly like components have been given like numerals. In this case however the links 20 are replaced by flexible cables or other flexible wires or lines 27 which are attached to the blades 12 adjacent their trailing edges and at equi-spaced circumferential positions to a circular or annular ring 28 which surrounds the central turbine shaft 15 but which is free to move relative to the shaft 15. The cables or members 27 are always in tension except at startup and therefore guides 21, rollers 22 or annular space 25 as used in the embodiment of FIG. 1 are not required.

The rings or guides 23 (and 28) are free to move a limited distance in any radial direction in response to fluid dynamic force on blades 12 and during rotation of the rotor are positioned eccentrically as illustrated. The blade adjustment mechanism is thus a passive system.

Assuming that the wind direction is as indicated by the arrow marked 29 in FIGS. 1(a) and 1(b), a blade 12 on the upstream side of the shaft 15 [blade 12 in position X of FIG. 1(a)] experiences a downstream fluid dynamic force which tends to move its trailing edge downstream, at the same time pushing its corresponding link 20 and roller 22 in FIG. 1(a), so that annular guide 23 moves downstream with its movement limited by contact with the shaft 15. A blade 12 on the downstream side of the shaft 15 [position Y in FIG. 1(b)] also experience a downstream hydrodynamic force which tends to move its trailing edge downstream, at the same time pulling its corresponding link 20 and roller 22 also causing guide 23 to move downstream until limited by contact with the shaft 15. Blades 12 moving upstream and downstream [positions Z1 and Z2 in FIGS. 1(a) and Z3 and Z4 in FIG. 1(b)] generate some side force but this has little effect on the direction of the resultant force.

In the embodiment shown in FIG. 2, the tension in the cables 27 generated by centrifugal force is balanced on all blades 12, so the downwind fluid dynamic forces act in the same way as in the embodiment shown in FIGS. 1(a) and (b). Thus in both embodiments the guides or rings 23 and 28 are in contact with and effectively roll around the central shaft 15, always near the downstream extremity of their travel, and the blades 12 pitch in an approximately sinusoidal pattern as the turbine rotor rotates. This is because the attachment point of the links 20 or cables 27 to the guides or rings 23 and 28 respectively move towards and away from the shaft 15 as the guides or rings 23 and 28 rotate eccentrically around the shaft 15 with the inner circular surfaces of the guides 23 and 28 in rolling contact with the outer surface of the shaft 15. This is apparent in FIGS. 1(a) and (1(b) which show the turbine rotor in a different positions approximately 60 degrees apart showing how the ring 23 rolling around the shaft 15 as the turbine rotates. During this movement also, the rollers 22 of each link 20 roll relatively backwards and forwards in a tangential direction along the annular groove or track 25 because the links 20 are constrained by the guides 21 to only move radially.

The pitch amplitude of the blades 12 is determined by (i) the distance between the blade pivot 17 on the radial arm 14 and the attachment point of the link 20 or cable 27, and (ii) the radial clearance between the guides 23 and 28 and the shaft 15. A pitch offset can be created by changing the length of links 20 or cables 27.

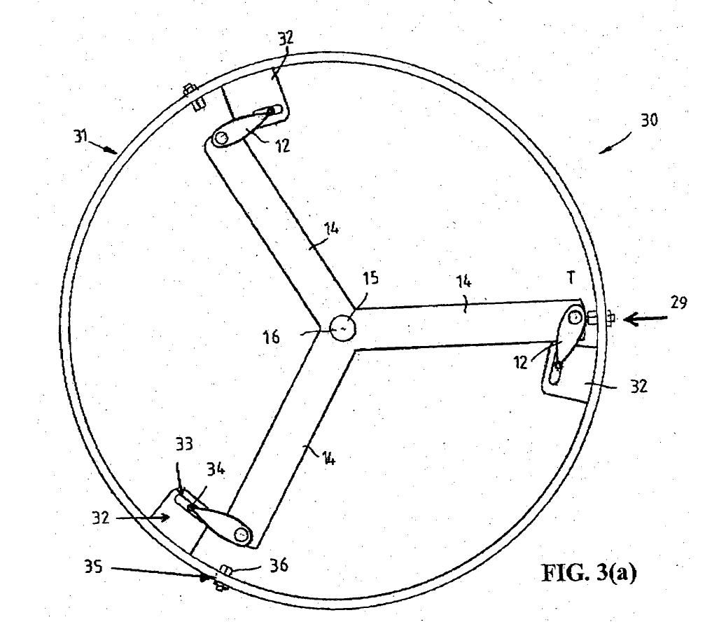

Referring now to FIG. 3(a), there is illustrated a further embodiment of turbine rotor 30 according to the invention which again includes a support frame having sets of radial arms 14 between which pivotally mounted blades 12 are supported. In this case however, the small ring 28 in FIG. 2 is replaced by a large diameter ring 31 which is located externally of the blades 12 with clearance around the outside of the blades 12. Three circumferentially spaced tabs 32 are mounted to the inner side of the ring 31 and extend radially inwardly thereof to lie in a plane which is substantially normal to the axis 16 of the turbine rotor 30. Each tab 32 includes au elongated slot 33 which extends in a generally circumferential direction or a direction at right angles to the radius of the rotor 11. The trailing ends of the blades 12 are provided with pins or rollers 34 which are received in the slots 33 and which can move in opposite directions therealong.

A series of adjusting screws 35 are provided adjacent but forwardly of each tab 32, the screws 35 extending to the inner side of the ring 31 to define stops 36 for engagement by the sides of the blades 12 (or arm 14). Pitch of the blades 12 in this case is now limited by the stops 36 of the adjusting screws 35 on the ring 31 contacting a blade 12 (or arm 14) on the upstream side as shown at position T in FIG. 3(a), and pitch amplitude is determined by the radial clearance between the stops 36 of the adjusting screws 35 on the ring 31 and the circle defined by the outer surfaces of the blades 12 (or arms 14). The pitch offset can be adjusted by moving the tabs 32 and/or, slots 33 inwardly or outwardly relative to the ring 31.

In an alternative embodiment of turbine 36 shown in FIG. 3(b), the ring 31 may be placed inside the blades 12 with the tabs 32 externally of the ring 31, in which case pitch amplitude is limited by the ring 31 contacting the blades 12 on the downstream side. Variable stops may be provided between the ring 31 and blades 12 to enable variation of maximum pitch amplitude.

The turbine rotors 30 and 36 function in a similar manner to that described with reference to FIGS. 1 and 2 with the fluid dynamic force on the blades 12 on the upstream side of the shaft 15 pulling or pushing the ring 31 downstream with fluid dynamic forces on the blades 12 on the downstream side of the shaft 15 pushing or pulling the rings 21 downstream until limited by the stops 36 and/or contact between the ring 31 and a blade 21. The slots 33 allow the centre or the rings 31 to move relative to the axis of rotation so that the rings move eccentrically around the shaft 15 as the turbine rotor 36 rotates with the pins or rollers 34 of the blades 12 moving in opposite directions along the slots 33.

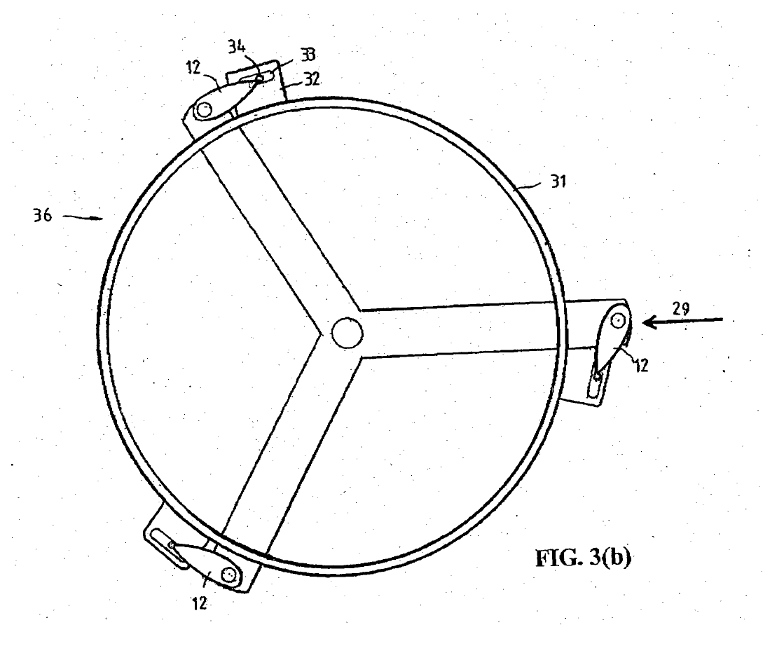

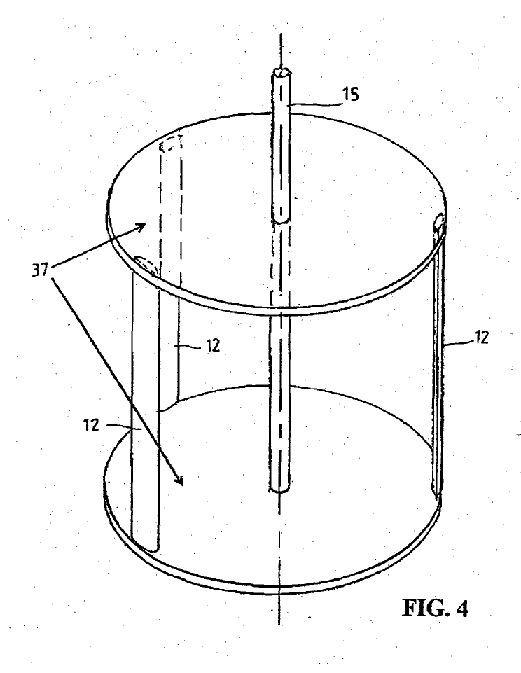

The blades 12 of the embodiments of FIGS. 1 to 3 are mounted on radial arms 14. In the alternative embodiment of the turbine rotor shown in FIG. 4, the radial arms 14 are replaced by a pair of axially spaced disks 37 to which the blades 12 are pivotally mounted at each end. Pitch control may be achieved by using one of mechanism as shown in FIG. 1, 2, 3(a) or 3(b).

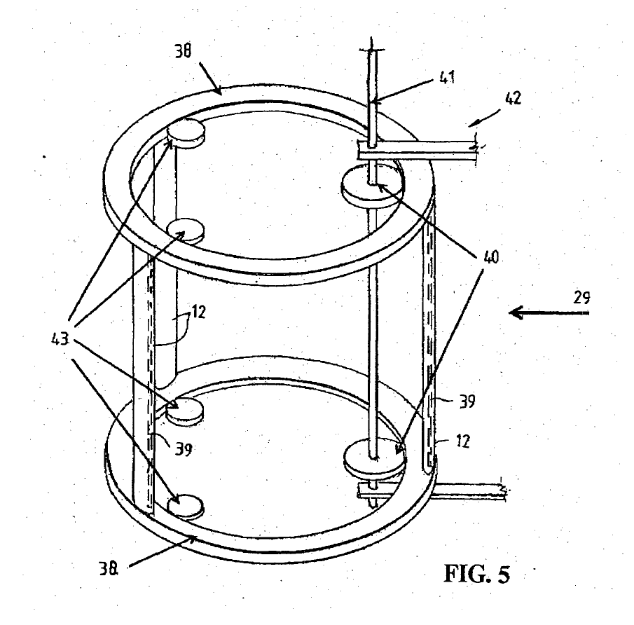

In the embodiment of turbine of FIG. 5, the radial arms 14 and central shaft 15 are replaced by a pair of rings 38 which are located relative to each other at spaced apart axial positions by rods 39 (shown in dotted outline), each of which passes through a blade 12 near its leading edge and each of which is rigidly mounted at opposite ends to the spaced rings 38. Each blade 12 is free to pivot about its rod 39, and its pitch is controlled using a pitch controlling mechanism of the type shown and described in relation to any one of FIG. 1 to 3(a) or 3(b).

One or both of the disks 37 in FIG. 4 or rings 38 in FIG. 5 may function as large diameter friction drive wheels and for this purpose, smaller diameter wheels or rollers 40 an provided in the case of the discs 37 on the outer side of the disks 37. In the case of the rings 38, the driven rollers 40 may be located either on the outer or inner side of the rings 38 and in contact with the outer or inner periphery of the rings 38. The wheels 40 are mounted on a shaft 41 which extends parallel to the blades 12 and to the axis of rotation of the rings 38, being supported by a support frame 42. The shaft 41 is coupled to any suitable load such as an electric generator or a pump. Idler rollers 43 may also be provided externally of the discs 37 or externally or internally of the rings 38 and opposite wheels 40 to locate the turbine rotor. In this arrangement, power is transmitted directly from the blades 12 at a relatively high peripheral speed and low tangential force to the small diameter driven wheels 40 on the high RPM shaft 41 to thus drive the load.

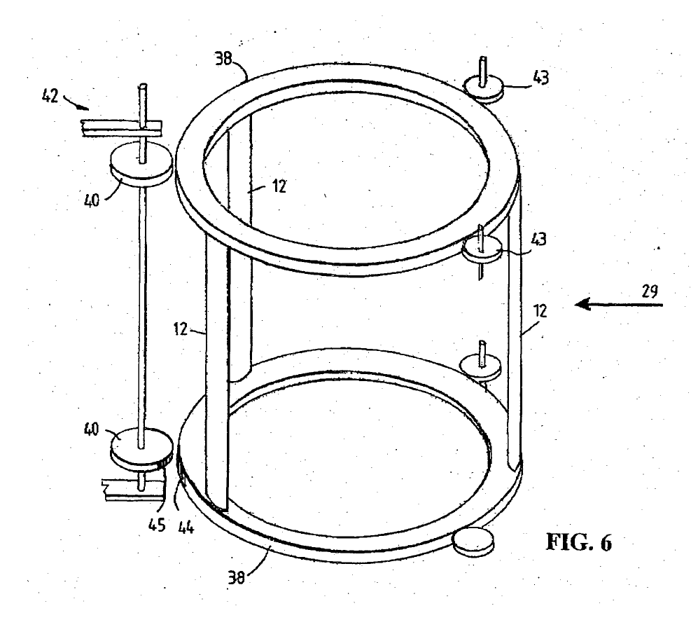

In the embodiment shown in FIG. 6 both the wheels 40 and idler rollers 43 are located externally of the rings 38. In each case, the driven wheels 40 are preferably located on the downstream side of the ring surface on which they bear, so that the downstream drag cm the rotor as a whole provides the required contact force to provide enough friction to prevent slippage. The discs 37, the rings 38 and the driven wheels 40 may have teeth 44 and 45 which mesh in the manner of gears to provide a positive drive, or the discs 37, the rings 38 and wheels 40 may be smooth and rely on friction to transmit power to driven wheels 40. Alternatively, the discs, 37, the rings 38 and wheels 40 may be in the form of pulleys or sprockets for belt or chain drive respectively. In yet a further alternative, force may be transmitted by friction with a roller rolling on a flat ring which rotates with the turbine.

Because the driven wheels 40 have a much smaller diameter than the disks 37 or rings 38, they will drive the load at a much higher angular velocity than that of the disks 37 or rings 38, thus eliminating the high torque central shaft and either eliminating the gearbox or requiring only a relatively low torque, low cost gearbox instead of the conventional transmission via a central shaft as shown in FIGS. 1-3.

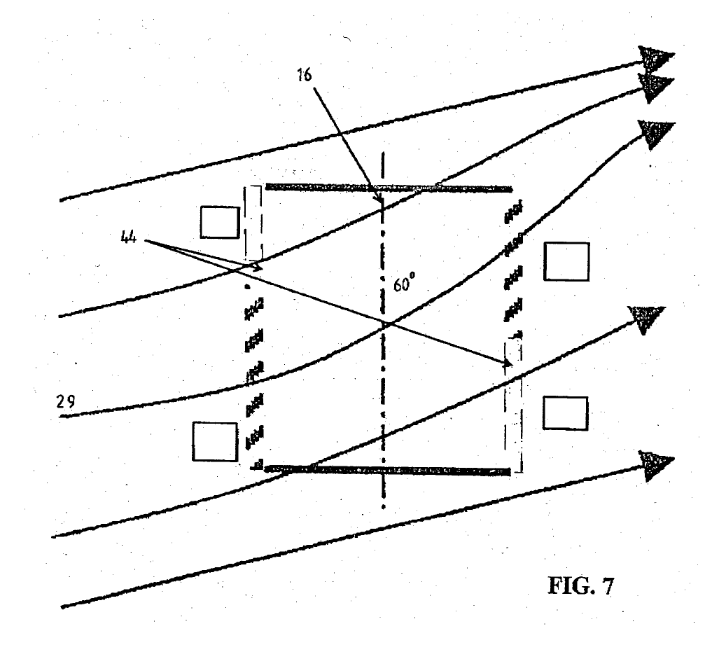

To increase the power output in water, the axis of rotation 16 of a turbine rotor of the type described above may be inclined at approximately 60° to the flow direction 29 (or 30° to the vertical) so that part 44 of the blades 12 are exposed to undisturbed flow on their downstream pass, effectively increasing the swept area as shown in FIG. 7. Radial arms may also be provided with camber, concave on the upstream side so as to generate forward torque by lift on unstalled arms moving upstream, and by drag on the stalled arms facing downstream.

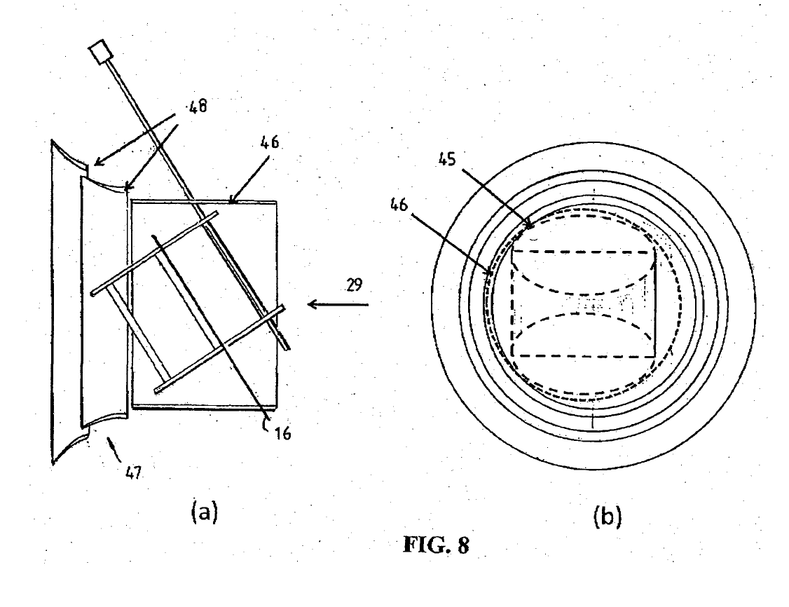

A skewed axis 16 as shown in FIG. 8(a) results in a swept area 45 comprising a rectangle with half ellipses at top and bottom, which can fit fairly neatly into a duct 46 of fixed circular cross section as shown in FIG. 8(b). This duct 46 may have on its downstream side a diverging section 47 comprising spaced slats 48 of high lift cambered aerofoil section as shown in FIG. 8(a) so as to form a diffuser. The slats 48 may be fabricated from FRP or other suitable material.

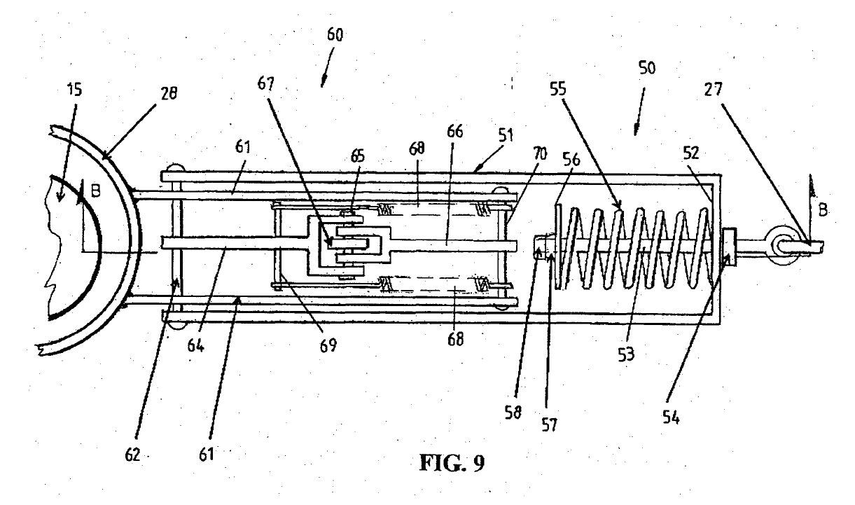

An over-speed control mechanism 50 may be used at the inner end of each control rod 20 between the control rod 20 and guide or ring 23 or alternatively the mechanism 50 may be provided between the cable 27 and ring 28 as illustrated in FIG. 9. The mechanism 50 includes an elongated release housing or frame 51 and having an end wall 52 through which a shaft 53 extends. The shaft 53 may be threaded to a pitch adjustment nut 54 located on the outside of the end wall 52. A compression spring 55 surrounds the shaft 53 and is located between a stop plate 56 and end wall 52. The spring 55 is preloaded by tightening a nut 57 and locknut 58 in threaded engagement with the inner end of the shaft 53. Preloading of the spring 55 can be achieved while maintaining the pitch adjustment nut 54 at its outer end in a fixed position.

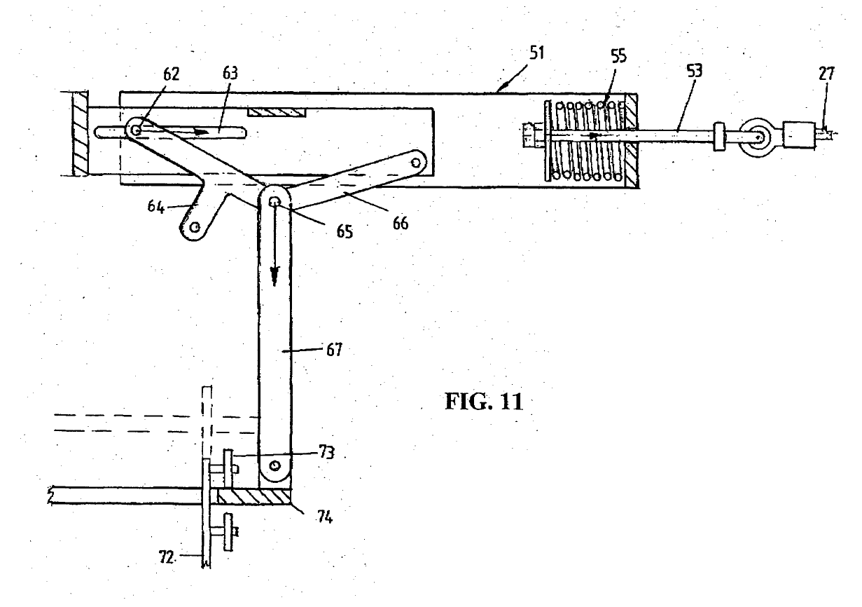

As the turbine rotational speed increases, centrifugal force on the blades 12 and hence tension in the cables 27 (or control rods 20) increases until the preload in the springs 55 is overcome, compressing the spring 55 as shown in FIG. 11 and allowing the control cables 27 (or rods 20) to move radially outwards, thus allowing the trailing edges of the blades 12 to move outwards, increasing drag and limiting the rotational speed. The spring preload can be adjusted until the desired governing speed is achieved. Whilst the spring 55 is shown to be a compression spring, it may alternatively comprise a tension spring attached between the shaft 53 and frame 51.

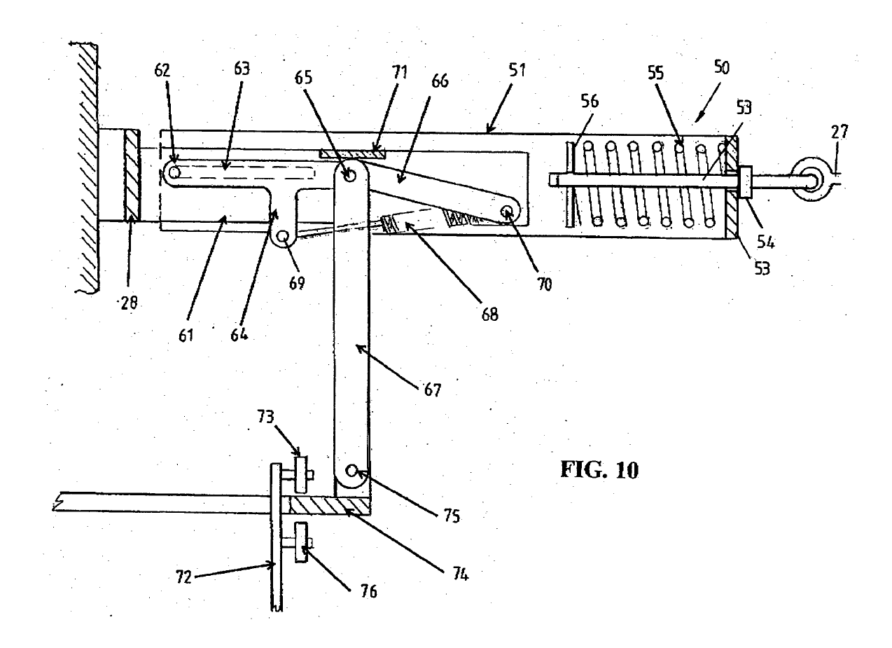

A deactivation mechanism 60 may also be provided and in this embodiment is associated with the over-speed control mechanism 50 to deactivate the turbine so it produces little or no torque and can be easily. stopped. A deactivation mechanism 60 may be provided for each blade 12 as shown in plan view in FIG. 9 and in sectional elevation B-B in FIG. 10. For each blade 12, a pair of arms 61 is fixed to the eccentric ring 28 and radiates outward therefrom. A pin 62 connecting opposite sides of release frame 51 passes through slots 63 (FIGS. 10-12) in arms 61 and is prevented from sliding radially outwards during normal operation. The pin 62 carries a T-shaped inner link 64 which is attached by another pin 65 to an outer link 66 and a vertical link 67. A pair of springs 68 is connected to the inner link 64 by a pin 69 and to the outer link 66 by a in 70. During normal operation, tension in these springs 68 keeps pin 65 up against a retaining plate 71 fixed to arm 61 of frame 51, shown in FIG. 10 but omitted from FIG. 9 for clarity, which limits upward movement of pin 65 and attached links 64, 66 and 67 and defines an over-centre lock.

The vertical link 67 is pivotally connected by pin 75 to a ring 74 which rotates with the turbine rotor. A non-rotating vertical deactivation link 72 extends upwardly. on the inside of the ring 74 and carries upper and lower rollers 73 and 76 located above and below the ring 74.

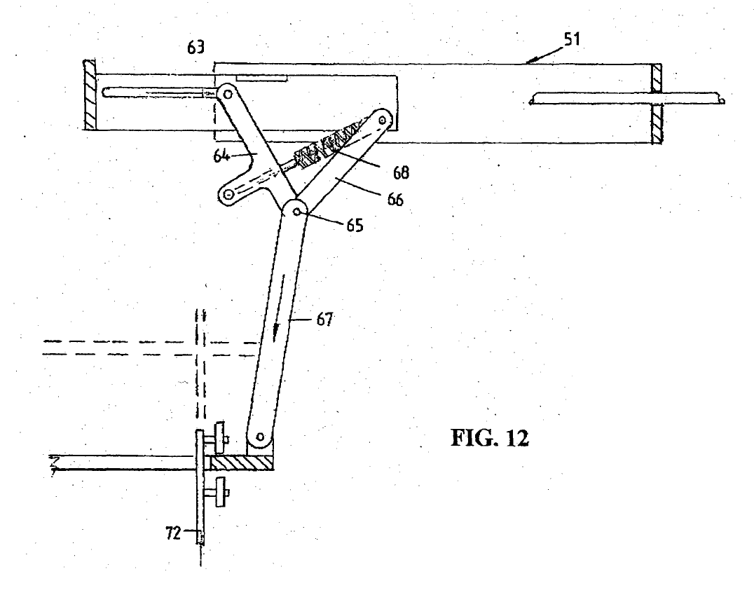

To deactivate the turbine, the non-rotating link 72 is pulled downwards so that wheel 73 contacts the rotating ring 74 which is attached to a vertical link 67 for each blade 12 by pin 75. Link 67 pulls pin 65 downward, initially against the tension in springs 68, then assisted by this tension. As pin 65 moves downward, shown in FIGS. 11 and 12, links 64 and 66 fold downwards past the over-centre position, allowing pin 62 to slide outwards in slots 63 so that frame 51 also moves outwards under the action of centrifugal force as long as the turbine rotor is rotating. This outward movement allows the trailing edges of the blades 12 to swing or pivot freely outwards without compressing spring 55, thereby greatly increasing drag and allowing the turbine to be easily stopped by means of a brake on the shaft 15.

Resetting the turbine is the reverse of the above process, namely non-rotating link 67 is pushed upwards so that wheel 76 contacts the lower side of the rotating ring 74, pushing it and vertical links 67 upwards until the pin 65 again contacts retaining plate 71 to reestablish the stable over-centre position.

It will be appreciated that the embodiments of the invention may be considerably varied without departing from the inventive concept of the invention. Thus the rotor frame 13 may be a multi-armed frame, in the form of spaced discs or annular members or in any other configuration which will support the blades 12. Similarly the blades 12 and rings or annular members 23 and 28 may be in various configurations. The links 20 rather than having the rollers 22 may simply terminate in pins which will slide in opposite directions along the groove or track 25. The rings 23 and 28 may also be elongated and in the form of tubular members located around the shaft 15. As stated above, the single groove or track 25 may be replaced by a plurality of grooves or tracks on a common radius associated with each link 20 or cable 27. The links or cables may be captured to the member carrying the grooves or tracks.

The rings 31 of the embodiments of FIGS. 3(a) and (b) may be replaced by members of any shape or configuration provided that they include the stops 26 for limiting the pitch amplitude, and slots 33 which allow for relative movement of the centre of the member and its axis of rotation.

Blades 12 may be provided with both an over-speed control mechanism and deactivation mechanisms or only one of those mechanisms. Mechanisms other than those described may be used for this purpose.

The pitch control mechanism of the invention by allowing pivotal movement of the blades which reduces their angle of attack eliminates stall as found often in conventional turbines. Each blade is also connected near its trailing edge to a ring or other pitch controlling member which allows blades to pitch with trailing edge downstream as they move across the flow on both their upwind/upstream and downwind/downstream passes, while at the same time constraining blades to near zero pitch as they travel upstream and downstream, such that they pitch in a sinusoidal regime thereby increasing efficiency. Further the energy extraction methods disclosed eliminate the high cost of large shafts and step-up gearboxes or multi-pole generators previously needed due to low rotational speed.

The terms “comprising” or “comprises” as used throughout the specification and claims are taken to specify the presence of the stated features, integers and components referred to but not preclude the presence or addition of one or more other feature/s, integer/s, components or group thereof. Further, the reference to prior art herein is not to be taken as acknowledgement that such prior art constitutes common general knowledge in the art.

Whilst the above has been given by way of illustrative embodiment of the invention, all such variations and modifications thereto as would be apparent to persons skilled in the art are deemed to fall within the broad scope and ambit of the invention as defined in the appended claims.

1-26. (canceled)

27. A turbine comprising:
a rotor having an axis of rotation oriented substantially normal to a direction of flow;
a blade support frame;
three or more blades spaced from and extending substantially parallel to the axis of rotation of said rotor, each said blade being pivotally mounted to said rotor frame for rotation about an axis extending substantially parallel to said axis of rotation, the axis being disposed forward of the point on the blade through which fluid dynamic lift forces act, such that a trailing edge of each said blade pivots downstream or downwind solely due to fluid dynamic lift forces on each said blade so as to reduce an angle of attack of each said blade, the amplitude of said pivoting motion being limited by link coupled at an outer end to the trailing edge of the blade and at an inner end to a ring which is free to move a limited distance in any radial direction relative to the axis of rotation of said turbine such that said ring is always at its downstream limit of travel due to the downstream fluid dynamic forces acting on the blades, said blades thereby being constrained to pitch in an approximately sinusoidal motion during rotation of said rotor frame.

28. A turbine as claimed in claim 27 wherein said link which couples the trailing end of each said blade to said ring comprises one of a rigid link or flexible member or cable.

29. A turbine as claimed in claim 27 wherein said rotor frame is mounted on a central shaft extending along said axis of rotation and wherein said ring is located around said shaft and wherein said radial movement of said ring is limited by contact with said shaft.

30. A turbine as claimed in claim 27 wherein said ring includes a circular groove arranged concentrically of said ring, and wherein an end of each said link is located within said groove.

31. A turbine as claimed in claim 30 wherein each said link terminates in a roller which is located within said groove.

32. A turbine as claimed in claim 27 wherein said link is attached at its inner end to said ring and at equi-spaced positions around said ring.

33. A turbine as claimed in claim 27 wherein said ring includes a plurality of circumferentially spaced members corresponding in number to the number of blades, slots in each said member and means at the trailing end of each said blade for receipt in and cooperation with respective said slots.

34. A turbine as claimed in claim 33 wherein said ring is provided externally of said blades and wherein said members are located on the inner side of said ring.

35. A turbine as claimed in claim 33 wherein said ring is provided internally of said blades and wherein said members are located on the outer side of said ring.

36. A turbine as claimed in claim 27 wherein said rotor frame includes axially spaced apart sets of radial arms, each said blade being pivotally mounted at opposite ends to the corresponding radial arms of each set.

37. A turbine as claimed in claim 27 wherein said rotor frame comprises a pair of axially spaced apart discs or annular members, said blades being pivotally mounted at each end to said discs or annular members.

38. A turbine as claimed in claim 37 and including one or more wheels in peripheral contact with the periphery of one or both of said discs or annular members.

39. A turbine as claimed in claim 38 wherein said wheels are in frictional contact with said discs or annular members.

40. A turbine as claimed in claim 38 wherein said wheels and discs or annular members include gear teeth, said gear teeth of said wheels and discs or annular members being in meshing engagement.

41. A turbine as claimed in claim 27 wherein said axis of rotation is inclined in use at an angle of approximately 60° to the flow direction to increase the effective swept area.

42. A turbine as claimed in claim 27 in combination with a diffuser, said diffuser being of circular cross section and comprising a cylindrical section in which said turbine is located, and a trailing divergent section.

43. A turbine as claimed in claim 42 wherein said divergent section comprises a plurality of slats of aerofoil section defining slots therebetween through which fluid may flow to keep the flow attached.

44. A turbine as claimed in claim 27 including a preload spring between an inner end of each link and said ring whereby a centrifugal force on the blades overcomes the spring preload and compresses the spring when the desired maximum rotational speed is reached, thereby reducing the aerodynamic efficiency and limiting the rotational speed of said turbine.

45. A turbine as claimed in claim 27 including a deactivation mechanism adapted to permit said blades to pivot freely without the constraint of the pitch control member.

46. A turbine as claimed in claim 45 wherein said deactivation mechanism comprises a releasable over-centre link assembly associated with each said blade.
